(19) United States
(12) Patent Application Publication
(10) Pub. No.: US 2012/0154297 A1
(43) Pub. Date: Jun. 21, 2012

(54) DISPLAY-SCREEN ADAPTATION FOR INTERACTIVE DEVICES

(75) Inventors: Bernie Schultz, Bothell, WA (US); Rajesh Manohar Dighde, Redmond, WA (US); Curt Aumiller, Redmond, WA (US)

(73) Assignee: MICROSOFT CORPORATION, Redmond, WA (US)

(21) Appl. No.: 13/049,729

(22) Filed: Mar. 16, 2011

Related U.S. Application Data
(60) Provisional application No. 61/425,678, filed on Dec. 21, 2010.

(51) Int. Cl. G06F 3/041

(52) U.S. Cl. 345/173

(57) ABSTRACT

An enclosure for a display screen of an interactive device. The enclosure includes a corner member and a substantially horizontal first side member coupled to the corner member and presenting an inside-edge area configured to fittably receive a first edge of the display screen. The enclosure also includes a substantially horizontal second side member coupled to the corner member adjacent the first side member, the second side member presenting an inside-edge area configured to fittably receive a second edge of the display screen. The enclosure also includes a transparent cover sheet arranged over the display screen, and a force-reception area arranged on one or both of the corner member and the first side member.

### CROSS REFERENCE TO RELATED APPLICATIONS

This application claims priority to U.S. Provisional Patent Application 61/425,678, filed 21 Dec. 2010 and entitled NOVEL MANUFACTURING FOR INTERACTIVE DEVICES, the entirety of which is hereby incorporated by reference herein for all purposes.

### BACKGROUND

A wide range of interactive electronic devices are now available, and an even wider range may be envisaged for the near future. To manufacture such devices in a cost-effective manner, certain technologies may be ‘borrowed’ from more established product lines. For example, an interactive, touch-input display screen may include a liquid-crystal display (LCD) matrix designed for vertical orientation in non-interactive devices. As such, the industry standards that fix the various specifications of the LCD matrix may not fully contemplate its installation and use in an interactive device. Nevertheless, it is desirable that emerging interactive devices be designed for robust operation in a variety of environments, versatility over a range of usage scenarios, low-cost manufacture, and ease of serviceability.

### SUMMARY

Accordingly, one aspect of this disclosure provides an enclosure for a display screen, which is installed substantially horizontally, or tilted or inclined in an interactive device. The enclosure is assembled from compatible corner and side members. Such modular construction is readily integrated to various interactive devices. The enclosure includes a transparent cover sheet arranged over the display screen, and a force-reception area arranged on one or both of a corner member and a side member. The force-reception area may be configured to receive a substantially vertical reaction force that elevates the enclosure and the display screen and counteracts the downward force of a user's touch input on the display screen.

The summary above is provided to introduce a selected part of this disclosure in simplified form, not to identify key or essential features. The claimed subject matter, defined by the claims, is limited neither to the content of this summary nor to implementations that address problems or disadvantages noted herein.

### BRIEF DESCRIPTION OF THE DRAWINGS

FIGS. 1 and 2 show aspects of example interactive devices in accordance with embodiments of this disclosure.

FIG. 3 shows aspects of a display-screen enclosure for an interactive device in accordance with an embodiment of this disclosure.

FIGS. 4 through 11 are cross-sectional views of example interactive devices through a first side member of the display-screen enclosure, in accordance with embodiments of this disclosure.

FIG. 12 illustrates an example method for installing a display screen in an interactive device in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see. Engineering scale drawings of other embodiments may be found in the provisional patent application to which this application claims priority.

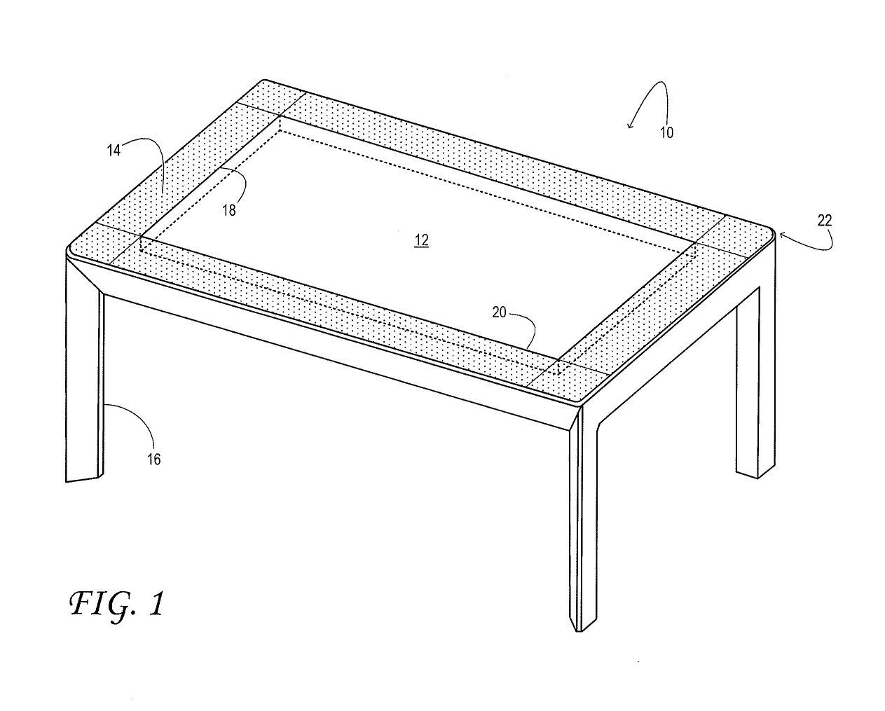

FIG. 1 shows aspects of an example interactive device 10 in one embodiment. The interactive device includes display screen 12, enclosure 14, and legs 16. In one embodiment, the display screen may be a liquid-crystal display (LCD). In other embodiments, it may be an organic light emitting diode (OLED) display, a plasma display panel (PDP), or a flexible display component, for example. In the illustrated embodiment, the display screen is rectangular, having a first edge 18 and a second edge 20 orthogonal to the first edge. It will be understood, however, that this disclosure fully embraces display screens of virtually any shape and technology that may be used in an interactive device.

In some embodiments, display screen 12 may itself be interactive. In other words, it may accept user input as well as providing display output. For example, the display screen may be a touch-sensitive display. Input capability may be provided via resistive, capacitive, or vision-based touch-input structures included in or external to the display screen, for example. Embedded in the display screen or below it, an integral vision or sensing system may be configured to record video of a user's hands or other objects on the display screen, thereby providing input data.

In some embodiments, display screen 12 may be operatively (physically or via a remote device) coupled to a computer (not shown in the drawings), that receives touch-input data, or other input data, and provides output data for forming a display image.

Enclosure 14 is the structure configured to receive display screen 12 in a substantially horizontal orientation. The term ‘substantially horizontal’, as used herein, refers to orientations that are within 20 degrees of horizontal. Naturally, this term may also refer to orientations much closer to the horizontal—within 5 degrees, for instance. On the other hand, tilted display screens facing upward or downward by as much as 45 degrees may also be accommodated in the enclosure. Continuing in FIG. 1, the enclosure includes a transparent cover sheet 22 arranged over the display screen. The transparent cover sheet may be a glass or polymer sheet (polyacrylic, polycarbonate, etc.) thick enough to protect the display screen from excessive touch pressure, but thin enough to transmit the user's touch input; it can be strengthened in such cases by optically bonding to the display screen. In one embodiment, the transparent cover sheet may support an anti-optical indexing element, such as an anti-Newton ring. In the illustrated embodiment, the transparent cover sheet is arranged over the entire top surface of the interactive device—i.e., the enclosure and the display screen. In other embodiments, the transparent cover sheet may be arranged over the display screen only, or over the display screen and a portion of the enclosure. In additional embodiments, the interactive display screen may be set proud to surrounding enclosure.

In the illustrated embodiment, interactive device 10 includes legs 16. The legs are configured to support enclosure 14 and its contents. The legs support the enclosure horizontally, transmitting to the enclosure a substantially vertical reaction force, which opposes the weight of the enclosure and its contents. FIG. 1 shows an interactive device having four legs; in other embodiments, the interactive device may include more or fewer than four legs, and the legs may support the enclosure in an inclined (though substantially horizontal) orientation to facilitate interaction with one or more users.

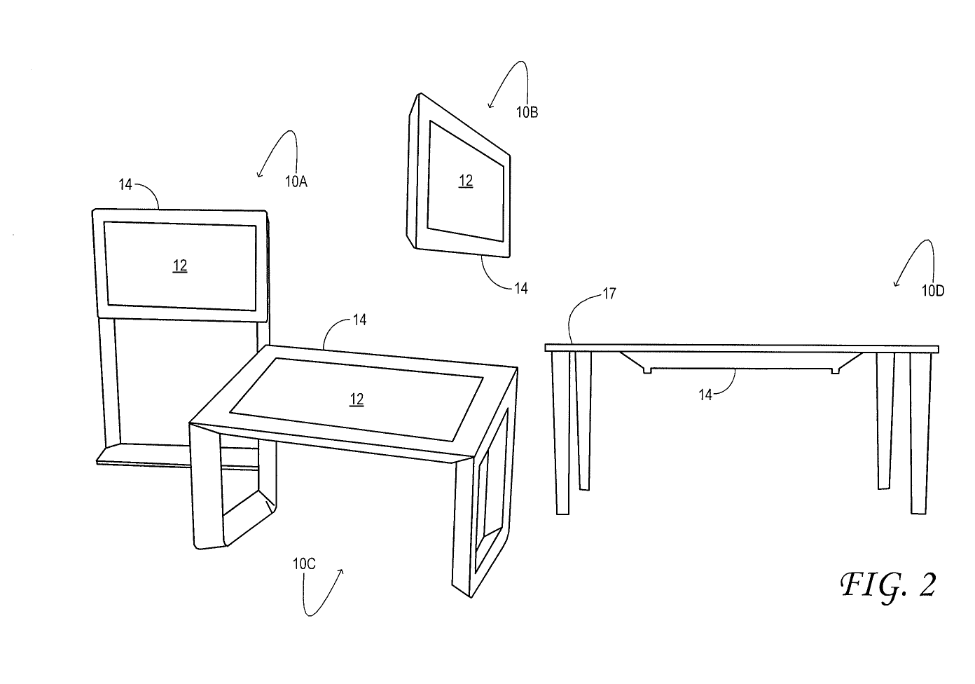

FIG. 2 shows aspects of other example, interactive devices that receive display screen 12 in enclosure 14. Interactive devices 10A and 10B, orient the display screen vertically; enclosure 14 is coupled to a free-standing mount in device 10A and to a wall mount in device 10B. In kiosk-type interactive device 10C, the display screen is inclined to facilitate viewing and interaction from one direction. Accordingly, the front legs are shorter than the rear legs. Interactive device 10D demonstrates a different mode of coupling between the legs and the enclosure. In this embodiment, the enclosure includes a customizable surround 17 to which the legs are coupled.

FIG. 3 shows aspects of enclosure 14 in greater detail. The illustrated enclosure includes four corner members 24 and four side members. More specifically, the drawing shows a substantially horizontal first side member 26 coupled to the corner member and presenting an inside-edge area 28 configured to fittably receive first edge 18 of display screen 12. The drawing also shows a substantially horizontal second side member 30 coupled to the corner member adjacent the first side member, the second side member presenting an inside-edge area 32 configured to fittably receive the second edge of the display screen. Naturally, in this rectangular embodiment, the enclosure includes two, substantially equivalent first side members and two, substantially equivalent second side members. In this and other embodiments, transparent cover sheet 22 may be arranged over at least a portion of the corner member and the first and second side members.

In some embodiments, first side member 26 and second side member 30 may be drawn from a set of compatible side members of different lengths, but identical in cross section. The first side member may be selected from the set based on the length of first edge 18 of the display screen, and the second side member may be selected based on the length of second edge 20. Corner member 24, accordingly, may be configured to couple to each of the compatible side members to enclose display screens of various sizes.

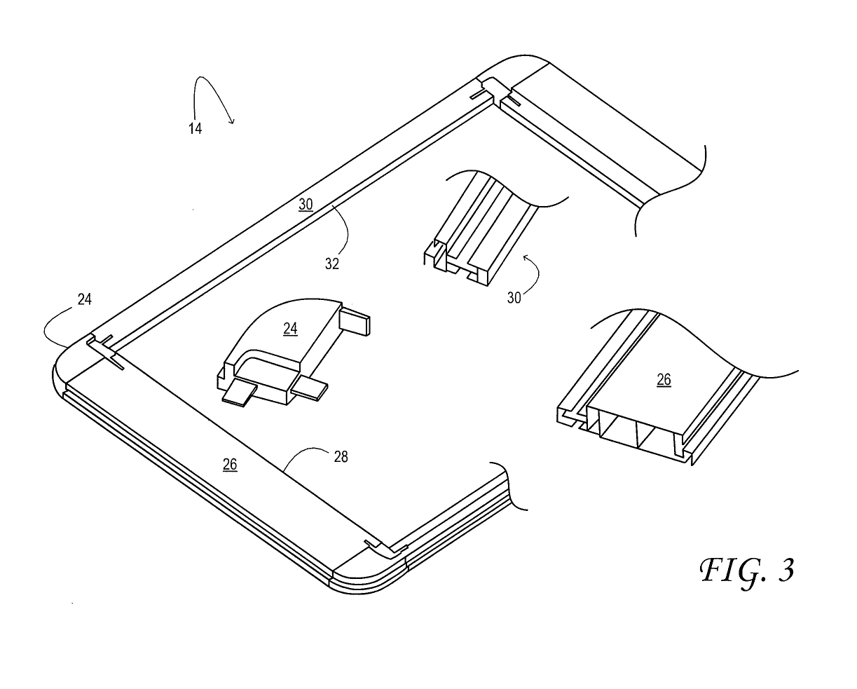

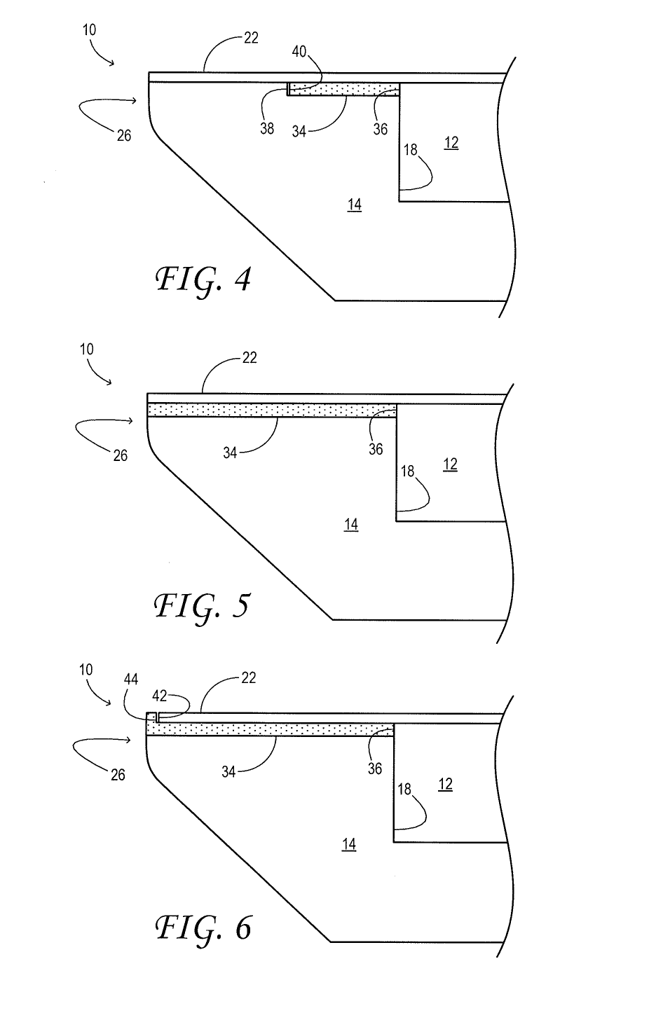

FIGS. 4, 5, and 6 are cross-sectional views of interactive device 10 through first side member 26. These drawings show other aspects of enclosure 14 in greater detail. In particular, they show registry feature 34 arranged on the bottom surface of transparent cover sheet 22. The registry feature may comprise a strip of plastic, or of a metal (in embodiments where electromagnetic transmission through the border area of the transparent cover is not envisaged). The registry feature is configured to accommodate display screen 12 in a fixed location beneath the transparent cover sheet, in registry with the enclosure. The registry feature may be press-molded to the transparent cover sheet, bonded to the transparent cover sheet with the aid of an adhesive, or attached in any other suitable manner.

In the illustrated embodiments, registry feature 34 includes at least one step edge aligned parallel to first side member 26. One step edge of the registry feature is denoted 36 and is aligned against first edge 18 of the display screen. The step edge makes it easier to register the display screen to the transparent cover sheet during assembly of the interactive device. Naturally, second side member 30 may also include a suitable registry feature with a step edge for aligning against second edge 20 of the display screen.

In the embodiment shown in FIG. 4, first side member 26 has a step edge 38, complementary to an additional step edge 40 of the registry feature. The various step edges of the registry feature and the complementary step edges of the first side member make it easier to register the transparent cover sheet to enclosure 14 during assembly of the interactive device. In the embodiment shown in FIG. 6, transparent cover sheet 22 has a step edge 42, complementary to an additional step edge 44 of the registry feature. The various step edges of the registry feature and the transparent cover sheet make it easier to align the registry feature to the transparent cover sheet. In these and other embodiments, the registry feature may facilitate transportation of the transparent cover sheet during manufacturing and/or assembly in addition to the advantages noted above.

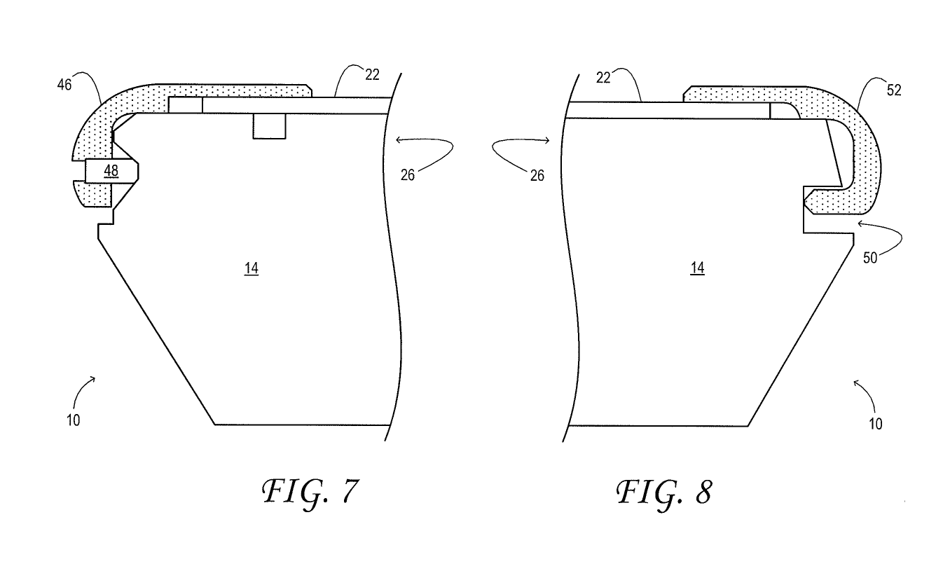

FIGS. 7 and 8 are additional cross-sectional views of interactive device 10 through first side member 26. These drawings show other aspects of enclosure 14 in greater detail. In particular, they show an external bezel attached to the first side member below transparent cover sheet 22, and extending over a portion of the first side member in face-sharing contact with the transparent cover sheet. External bezel 46 of FIG. 7 includes removable fastener 48 configured to attach the external bezel to the first side member. In FIG. 8, the first side member includes a groove 50 configured to snappably receive external bezel 52. Accordingly, the external bezel may be made of plastic material or another material offering suitable resiliency to allow it to snap into place. External bezels as disclosed herein may enable cost-effective replacement of the transparent cover sheet and/or display screen.

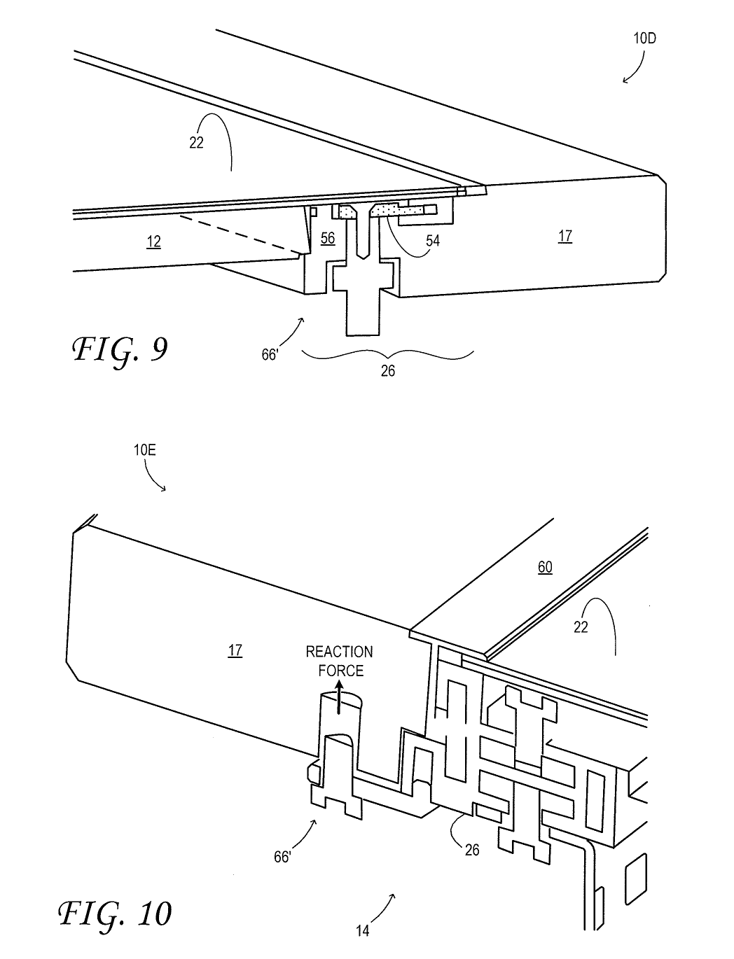

FIG. 9 is a cross-sectional view of interactive device 10D through first side member 26. Enclosure 14 includes cam 54. The cam is movable from a first position, in which display screen 12 is locked in place, to a second position, in which the display screen is removable. More specifically, in the first position, the cam pushes inward (to the left in FIG. 9) against a moveable portion 56 of the first side member, thereby locking the display screen in place. In the second position, the cam pulls outward (to the right in FIG. 9), so that the moveable portion of the first side member releases the display screen. In the illustrated embodiment, a fastener (not shown in the drawing) may be included to retain the cam in the first position. The fastener may be disposed below transparent cover sheet 22, and accessed by removal of the transparent cover sheet. With the transparent cover sheet lifted off, removal of the fastener allows the cam to be moved into the second position.

FIG. 9 also shows customizable surround 17 coupled to first side member 26, in lieu of an exterior bezel. FIG. 10 is a cross-sectional view of another interactive device 10E through first side member 26; it shows in more detail one mode of coupling the surround to the first side member. The drawing also shows internal bezel 60 disposed between the first side member and the surround. In this embodiment, the internal bezel extends over a portion of the first side member and a portion of the transparent cover sheet 22.

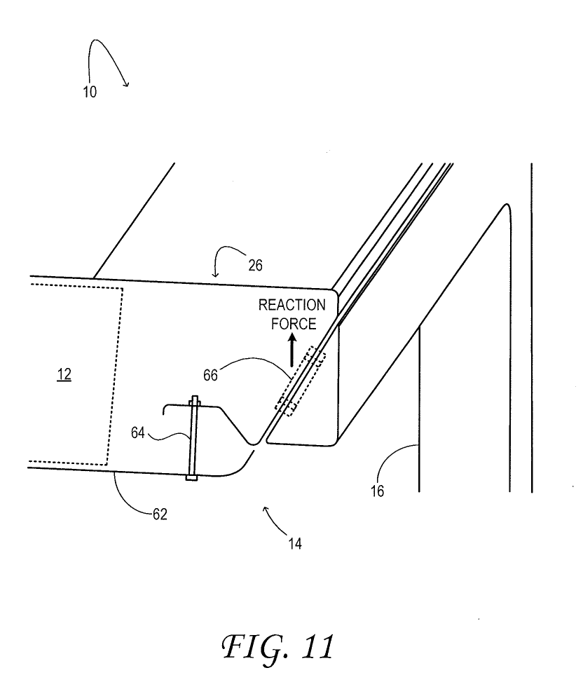

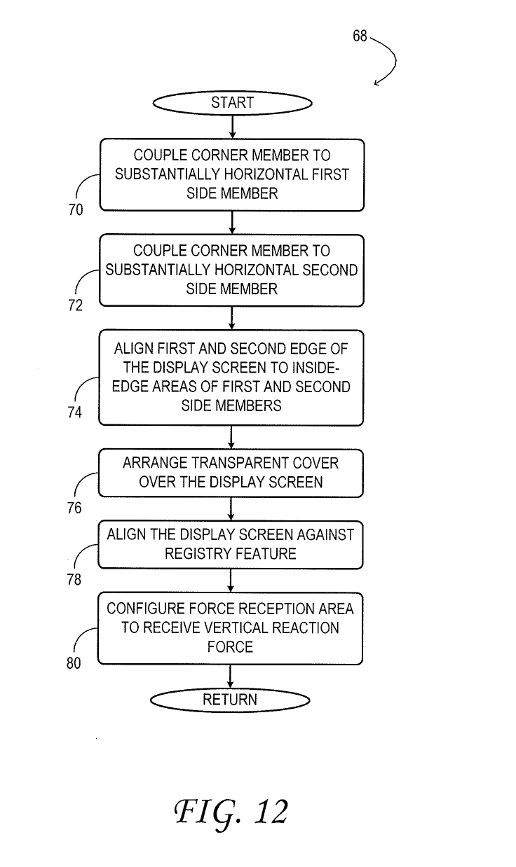

FIG. 11 is another cross-sectional view of interactive device 10 through first side member 26. As shown in this drawing, enclosure 14 may also include a mounting plate 62 configured to support display screen 12 from below. In the illustrated embodiment, the mounting plate is attached to the first side member. In other embodiments, it may be attached to the corner member and/or the first or second side members. The mounting plate may be configured to support the display screen over a range of substantially horizontal tilt angles—i.e., 0 to 20 degrees from horizontal. The tilt angle may be varied by adjustment of fastener 64, for example, which may include a screw thread. Accordingly, the mounting plate may include a plurality of thru-holes which accommodate this and other fasteners. In one embodiment, the pattern of the thru-holes may conform to the Video Electronics Standards Association (VESA) standard.

Continuing in FIG. 11, enclosure 14 also includes a force-reception area 66 arranged on first side member 26. In other embodiments, a force-reception area may be arranged on one or both of the corner member and the second side member, instead of or in addition to the first side member. The force-reception area is configured to receive a substantially vertical reaction force opposing the weight of the enclosure and contents. The reaction force elevates the enclosure and the display screen, and counteracts the downward force of a user's touch input on the display screen. In one embodiment, force-reception area 66 may include a plurality of thru-holes for fasteners that attach legs 16 to the first side member. Accordingly, the legs may be mechanically coupled to the force-reception area. Further, the force-reception area may be configured to isolate the enclosure and contents from vibration, impact, or shock, such as could be encountered on a moving vehicle (e.g., a cruise ship) or during vigorous usage scenarios. The illustrated position of force-reception area 66 is not intended to be limiting in any sense. In other embodiments, such as interactive devices 10D and 10E, the force-reception area may be located in the region of the enclosure that couples to a customizable surround. Accordingly, another example force-reception area 66′ is indicated in FIGS. 9 and 10.

The interactive devices described above may be assembled according to various methods. Some such methods are now described, by way of example, with continued reference to the above configurations. It will be understood, however, that the methods here described, and others fully within the scope of this disclosure, may be used to assemble other devices as well. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

FIG. 12 illustrates an example method 68 for installing a display screen substantially horizontally in an interactive device, the display screen having a first edge and a second edge orthogonal to the first edge.

At 70 of method 68, a corner member is coupled to a substantially horizontal first side member, the first side member presenting an inside-edge area configured to fittably receive the first edge of the display screen. At 72 the corner member is coupled to a substantially horizontal second side member, adjacent the first side member, the second side member presenting an inside-edge area configured to fittably receive the second edge of the display screen.

In one embodiment of this method, the first side member may be one of a plurality of side members of different lengths but identical in cross section. The first side member may be selected from the plurality of side members based on the length of the first edge of the display screen. In this and other embodiments, the corner member may be a first corner member used to install a first display screen in a first interactive device. Here, the method may further comprise coupling a second corner member to a third side member different in length than the first and second side members. The second corner member and the third side member may be used to install a second display screen in a second interactive device. This embodiment makes the assembly method substantially size-invariant, equally applicable to display screens and interactive devices of virtually any size.

At 74 the first edge of the display screen is aligned against the inside-edge area of the first side member, and, the second edge of the display screen is aligned against the inside-edge area of the second side member. At 76 a transparent cover sheet is arranged over the display screen. At 78 the display screen is aligned against a registry feature arranged on a bottom surface of the transparent cover sheet and configured to accommodate the display screen in a fixed location beneath the transparent cover sheet and in registry with the enclosure. At 80 a force-reception area arranged on one or both of the corner member and the first side member is configured to receive a substantially vertical reaction force that elevates the enclosure and the display screen. In one embodiment, this action may include bolting legs to the enclosure.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. An enclosure for a display screen installed in an interactive device, the display screen having a first edge and a second edge orthogonal to the first edge, the enclosure comprising:
a corner member;
a substantially horizontal first side member coupled to the corner member and presenting an inside-edge area configured to fittably receive the first edge of the display screen;
a substantially horizontal second side member coupled to the corner member adjacent the first side member, the second side member presenting an inside-edge area configured to fittably receive the second edge of the display screen;
a transparent cover sheet arranged over the display screen; and
a force-reception area arranged on one or both of the corner member and the first side member, the force-reception area configured to receive a substantially vertical reaction force that elevates the enclosure and the display screen and counteracts a downward force of a user's touch input on the display screen.

2. The enclosure of claim 1 wherein the first side member is one of a plurality of compatible side members of different lengths but identical in cross section, wherein first side member is selected from the plurality based on a length of the first edge of the display screen; and wherein the corner member is configured to couple to each of the compatible side members.

3. The enclosure of claim 1 wherein the transparent cover sheet is arranged over at least a portion of the corner member and of the first and second side members.

4. The enclosure of claim 1 further comprising a leg coupled to the force-reception area and configured to transmit the substantially vertical reaction force to the enclosure.

5. The enclosure of claim 1 further comprising a registry feature arranged on a bottom surface of the transparent cover sheet and configured to accommodate the display screen in a fixed location beneath the transparent cover sheet and in registry with the enclosure.

6. The enclosure of claim 5 wherein the registry feature includes a step edge aligned parallel to the first side member.

7. The enclosure of claim 6 wherein one or both of the first side member and the transparent cover sheet includes a step edge complementary to the step edge of the registry feature.

8. The enclosure of claim 1 further comprising a external bezel attached to the first side member below the transparent cover sheet, and extending over a portion of the first side member in face-sharing contact with the transparent cover sheet.

9. The enclosure of claim 8 wherein the first side member includes a groove configured to snappably receive the external bezel.

10. The enclosure of claim 8 further comprising a removable fastener configured to attach the external bezel to the first side member.

11. The enclosure of claim 1 further comprising a surround coupled to the first side member in lieu of an external bezel, with an internal bezel arranged between the first side member and the surround, wherein the internal bezel extends over a portion of the first side member and a portion of the transparent cover sheet.

12. The enclosure of claim 1 further comprising a mounting plate configured to support the display screen from below, wherein the mounting plate is attached to one or both of the corner member and the first side member.

13. The enclosure of claim 12 wherein the mounting plate is configured to support the display screen over a range of substantially horizontal tilt angles.

14. The enclosure of claim 1 further comprising a cam movable from a first position, in which the display-screen is locked in place, to a second position, in which the display screen is removable, and wherein removal of a fastener disposed beneath the transparent cover sheet allows the cam to be moved into the second position.

15. A method for installing a display screen substantially horizontally in an interactive device, the display screen having a first edge and a second edge orthogonal to the first edge, the method comprising:
coupling a corner member to a substantially horizontal first side member, the first side member presenting an inside-edge area configured to fittably receive the first edge of the display screen;
coupling the corner member to a substantially horizontal second side member, adjacent the first side member, the second side member presenting an inside-edge area configured to fittably receive the second edge of the display screen;
aligning the first edge of the display screen against the inside-edge area of the first side member and the second edge of the display screen against the inside-edge area of the second side member;
arranging a transparent cover sheet over the display screen; and
configuring a force-reception area arranged on one or both of the corner member and the first side member to receive a substantially vertical reaction force that elevates the enclosure and the display screen.

16. The method of claim 15 wherein the first side member is one of a plurality of side members of different lengths but identical in cross section, and wherein first side member is selected from the plurality based on a length of the first edge of the display screen.

17. The method of claim 15 wherein the corner member is a first corner member used to install a first display screen in a first interactive device, wherein the method further comprises coupling a second corner member to a third side member different in length than the first and second side members, and wherein the second corner member and the third side member are used to install a second display screen in a second interactive device.

18. The method of claim 15 further comprising aligning the display screen against a registry feature arranged on a bottom surface of the transparent cover sheet and configured to accommodate the display screen in a fixed location beneath the transparent cover sheet and in registry with the enclosure.

19. An interactive device comprising:
a display screen having a substantially horizontal first edge and a substantially horizontal second edge orthogonal to the first edge;
an the enclosure configured to receive the display screen, the enclosure comprising:
a corner member;
a substantially horizontal first side member coupled to the corner member and presenting an inside-edge area configured to fittably receive the first edge of the display screen;
a substantially horizontal second side member coupled to the corner member adjacent the first side member, the second side member presenting an inside-edge area configured to fittably receive the second edge of the display screen;
a transparent cover sheet arranged over the display screen; and
a force-reception area arranged on one or both of the corner member and the first side member, the force-reception area configured to receive a substantially vertical reaction force that elevates the enclosure and the display screen and counteracts a downward force of a user's touch input on the display screen; and
four legs coupled to the force-reception area, the legs configured to transmit the substantially vertical reaction force to the enclosure, thereby supporting the enclosure in a substantially horizontal orientation.

20. The device of claim 19 further comprising a cam movable from a first position, in which the display screen is locked in place, to a second position, in which the display screen is removable, and wherein removal of a fastener disposed beneath the transparent cover sheet allows the cam to be moved into the second position.
